(19) United States
(12) Patent Application Publication
(10) Pub. No.: US 2023/0169945 A1
(43) Pub. Date: Jun. 1, 2023

(54) INTERCHANGEABLE ELECTRIC GUITAR PICKUP SYSTEM

(71) Applicant: Gabriel Pérez Diaz, Nashville, TN (US)

(72) Inventor: Gabriel Pérez Diaz, Nashville, TN (US)

(21) Appl. No.: 17/535,770

(22) Filed: Nov. 26, 2021

(51) Int. Cl. G10H 3/18

(52) U.S. Cl. CPC G10H 3/183; G10H 3/181

(57) ABSTRACT

A novel mechanical mounting and electrical connection system for electric guitar pickups. The mechanical mounting component generally consists of one electric guitar pickup baseplate with one or more male elements and an electric guitar pickup module with one or more female elements configured to be press fitted into the male element of the baseplate for securing the position. The electrical connection component consists of one electric guitar pickup baseplate attached with a printed circuit board loaded with one or more spring-loaded contact connectors and one electric guitar pickup module attached with a printed circuit board with one or more connections slots for securing contact and connecting electronically each component.

### FIELD OF THE INVENTION

The present invention relates to an electric guitar pickup system, and more particularly to a detachable electric guitar pickup system that allows musicians an easy way to change their pickups on their electric guitar.

### BACKGROUND

Electric guitar pickups are the devices responsible for transforming the movement of the strings of the instrument into an electrical signal that can be amplified. Therefore, its characteristics are fundamental in the final result of the sound of the instrument.

Electric guitar pickups are purchased as an accessory and they come with their bare wires, which require, for proper installation, a technician or a person who has a basic knowledge of electronics. This step is mandatory to achieve a proper installation of this device on the guitar.

Current solutions of modular or interchangeable electric guitar pickup systems require, inmost cases, to heavily modify a standard musical instrument (guitar or bass guitar) by removing wood in it, to accommodate this systems of interchangeable pickups, or to buy an instrument that has been specially made for these systems but there are not standard instruments, making these solutions non practical.

There are no current solutions that allow a modular pickup system to be used without irreversibly modifying a guitar or having to buy a completely dedicated instrument suited to use his kind of system, commonly sold by the same companies that have come with this design on interchangeable pickups because they don't adapt to standard musical instruments.

### BRIEF SUMMARY OF THE INVENTION

The described invention allows to use a modular pickup system without the need of a specially designed musical instrument fitted to use this system, or irreversibly modifying the general aesthetic of an electric guitar.

The present invention comprises a novel mechanical mounting and electrical connection system for electric guitar pickups. The mechanical mounting component generally consists of one electric guitar pickup baseplate with one or more male elements, and an electric guitar pickup module with one or more female elements configured to be press fitted into the male element of the baseplate for securing the position. The electrical connection component consists of one electric guitar pickup baseplate attached with a printed circuit board loaded with one or more spring loaded contact connectors and one electric guitar pickup module attached with a printed circuit board with one or more connections slots for securing contact and connecting electronically each component.

### BRIEF DESCRIPTION OF THE DRAWINGS

Some embodiments of the present invention are illustrated as an example, and are not limited by the figures of the accompanying drawings, in which like references may indicate similar elements and in which:

FIG. 1 depicts a front top perspective view of one example of a fully assembled interchangeable electric guitar pickup system according to various embodiments of the present invention;

FIG. 2 depicts a front bottom perspective view of one example of a fully assembled interchangeable electric guitar pickup system according to various embodiments of the present invention;

FIG. 3 shows a front top perspective view of one example of an electric guitar pickup baseplate assembled with its various components according to various embodiments described herein;

FIG. 4 illustrates a front top perspective exploded view of one example of an electric guitar pickup baseplate, some fixed parts and its screws according to various embodiments described herein;

FIG. 5 shows a front top perspective exploded view of one example of an electric guitar pickup baseplate, some male positioning elements and a printed circuit board with some connectors according to various embodiments described herein;

FIG. 6 depicts a front top perspective exploded view of one example of an electric guitar pickup baseplate, a printed circuit board with some connectors and a 90 degree pin header connector according to various embodiments described herein;

FIG. 7 depicts a front top perspective view of one example of a fully assembled electric guitar pickup module according to various embodiments of the present invention;

FIG. 8 depicts a front bottom perspective view of one example of a fully assembly electric guitar pickup module according to various embodiments of the present invention;

FIG. 9 illustrates an exploded right side view of one example of an electric guitar pickup module according to various embodiments described herein;

FIG. 10 shows an exploded front top perspective view of one example of an electric guitar pickup module showing all its components according to various embodiments described herein; and

FIG. 11 depicts a front bottom perspective view of a fully assembled electric pickup guitar module and a partially assembled electric guitar pickup baseplate illustrating the electrical connection zone according to various embodiments of the present invention.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms including technical and scientific terms used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit, and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new Interchangeable electric guitar pickup system is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

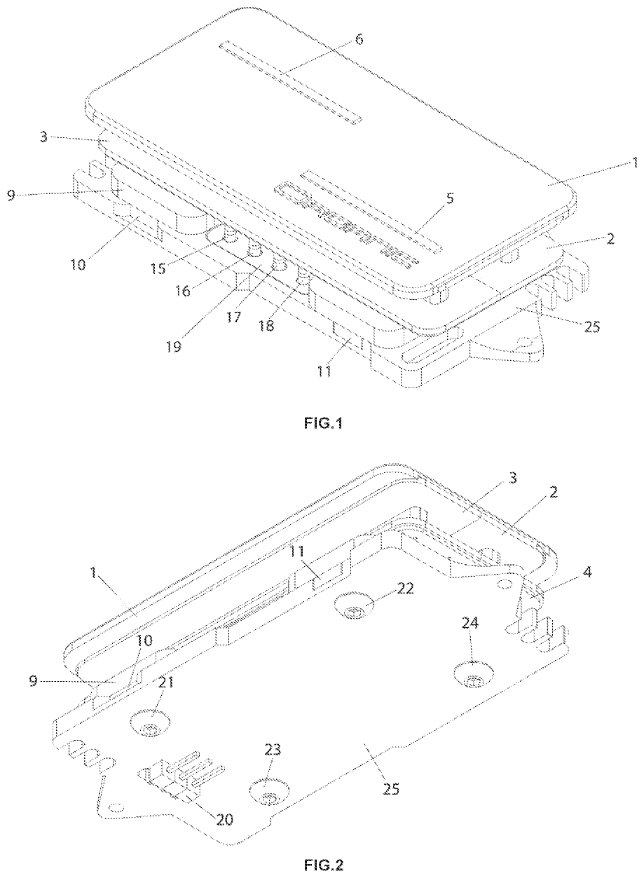

The present invention will now be described by referencing the appended figures representing preferred embodiments. FIG. 1 and FIG. 2 show a front perspective view of the fully assembled invention and all its components according to various embodiments described herein. FIG. 1 and FIG. 2 illustrate both elements of the invention, the electric guitar pickup module (module) and the electric guitar pickup baseplate (baseplate) once they are mounted together. Therefore, this is the position of the above-mentioned components that allows securing the position of the module, and electronically connect it to the baseplate.

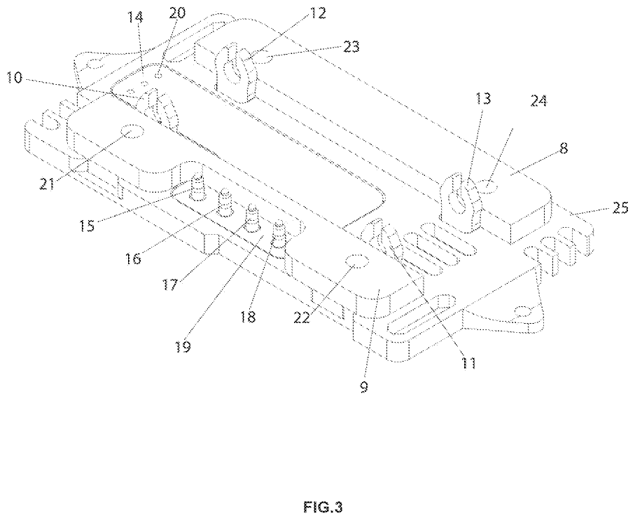

FIG. 3 depicts a top front perspective view of the fully assembled baseplate with its components installed on it. The main body of the baseplate 25 is the recipient of the elements that comprises the male part of the positioning mechanism 10, 11, 12, 13 and comprises part of the electrical components that ensure the electrical connection 15, 16, 17, 18, 19, 14 and 20 which will be explained in more details within the next figures. In preferred embodiments, the main body of the baseplate 25 may be made of a nonferrous metal, copper, brass, aluminum, or other similar material, which produces a highly durable and low weight surface to assemble the elements comprising the entire baseplate component.

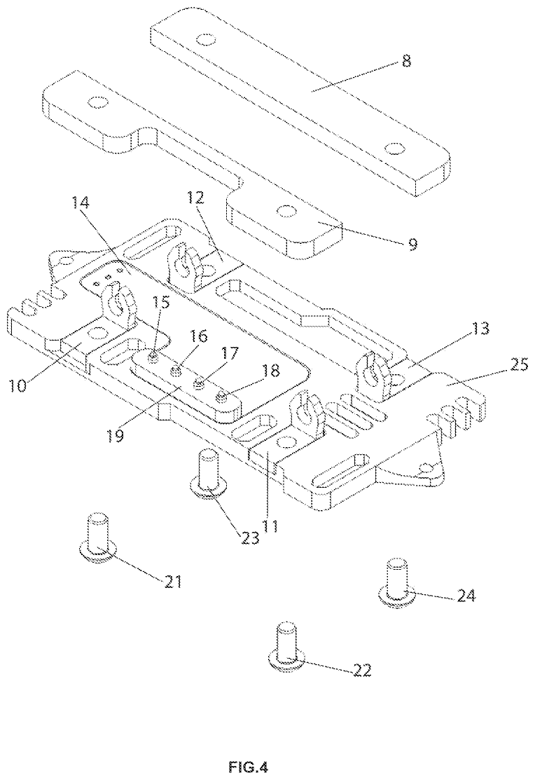

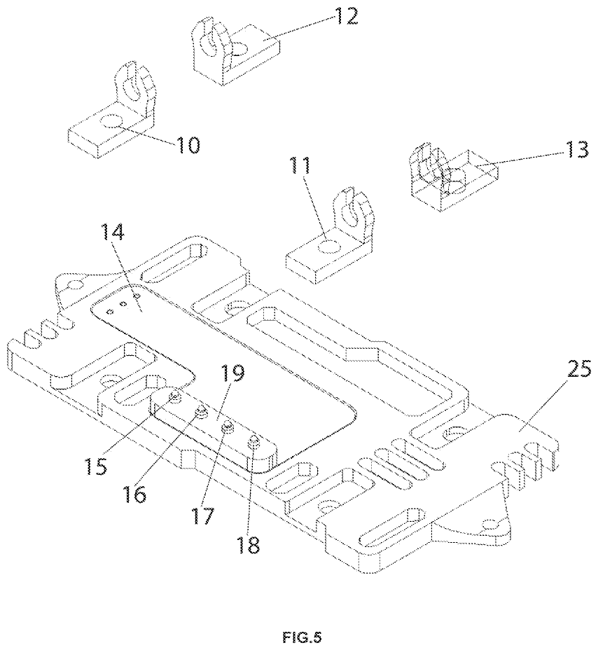

Referring now to FIG. 4, the male part of the positioning mechanism comprises four male connector elements 10, 11, 12 and 13 which are placed in the main body 25 positioning slots (as seen in FIG. 5) of the baseplate. These elements are preferred to be made of a high density plastic or other material, which ensures a high resistance and low degradation against friction. These four connector elements are held in position by two fixing elements 9 and 8 which are screwed onto the main body 25 using four screws 21, 22, 23 and 24. In preferred embodiments, these two fixing elements may be made of a nonferrous metal, copper, brass, aluminum, or other similar material, which produces a highly durable and low weight surface to assemble the elements comprising the entire baseplate component.

FIG. 5 depicts the electrical connection element assembled onto the main body 25 of the baseplate assembly. The elements comprising the electrical connection component are explained with more detail in the next figure.

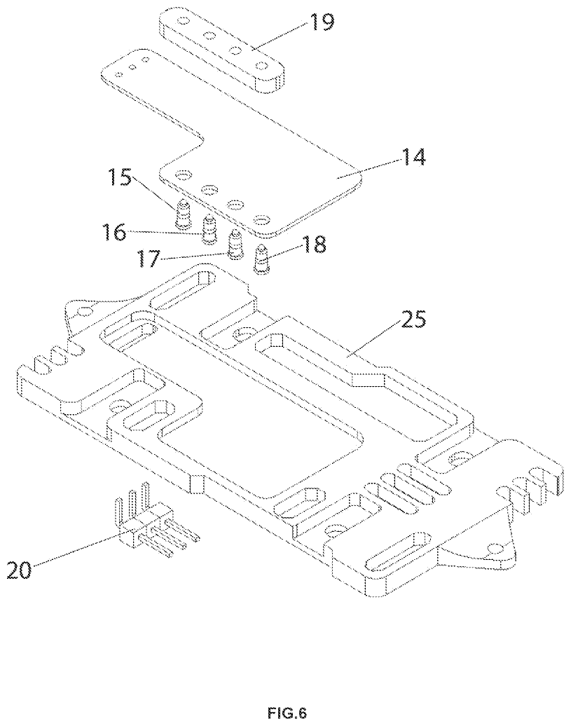

FIG. 6 shows a perspective exploded view of the electrical connection assembly for the baseplate, which comprehends a printed circuit board (PCB) 14, four spring-loaded contact connectors (connection pins) 15, 16, 17 and 18, a plastic housing element 19 and a 90 degree pin header connector 20 (L connector). The connection pins 15, 16, 17 and 18 are placed into the designated holes and soldered to the PCB 14, and then the plastic housing. 19 is installed and placed (as shown in FIG. 5). This assembly is placed onto the main body 25 and the L connector 20 is placed and soldered from the bottom of the main body itself 25 (as shown in FIG. 2). In some embodiments, due to the PCB 14 design, each header of the L-connector 20 conducts electricity between the header itself and one or more conductive pin 15, 16, 17, or 18, other possibilities or number of pin header and connection pins are not excluded.

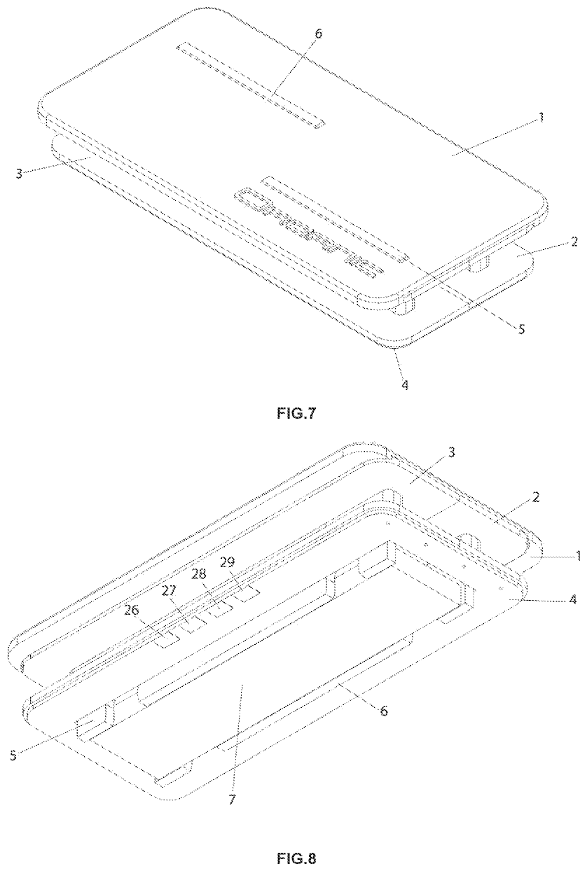

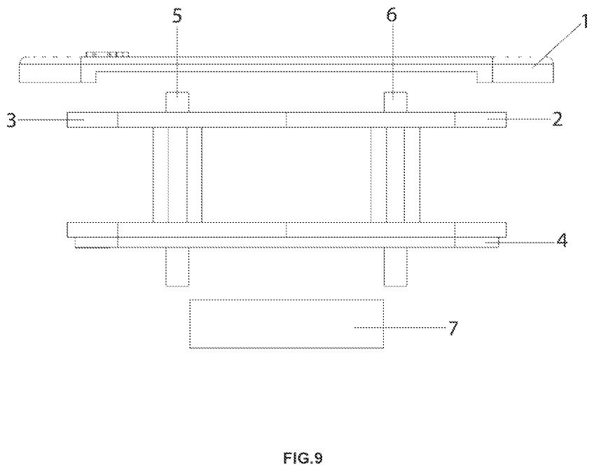

Referring now to FIG. 7 and FIG. 8, illustrate a top and bottom perspective view of the final assembly of the pickup module with its components installed on it. The pickup module comprises two bobbins elements 2 and 3 which are the recipient of the elements that comprehend the pickup module itself. The bobbin elements 2 and 3 may be made of plastic material such as polycarbonate or other similar material which produces a highly durable and smooth surface to assemble the elements comprising the entire pickup module. As shown in FIG. 7, the bobbins elements 2 and 3 are covered by a plastic cover 1 for aesthetic purposes also made of plastic or a similar material. Inside each bobbin element 2 and 3 is attached and fixed a metal core 5 and 6 which contains the female part of the positioning mechanism. FIG. 8 depicts, attached to the bottom of the bobbins elements 5 and 6, a PCB 4 with its connection terminals 26, 27, 28 and 29. In this example, between each metal core 5 and 6, underneath the bobbins elements 2 and 3, is attached and fixed a magnet 7 related to the electromagnetic functioning of an electric guitar pickup, a more detailed explanation is not relevant for this particular invention.

FIG. 9 shows a right side exploded view of the pickup module illustrating in a more detailed manner its above mentioned elements. From top to bottom: 1 plastic cover, bobbins element 2 and 3, inside each of them a metal core 5 and 6, underneath the bobbins a PCB board 4 and between the metal cores, a magnet 7.

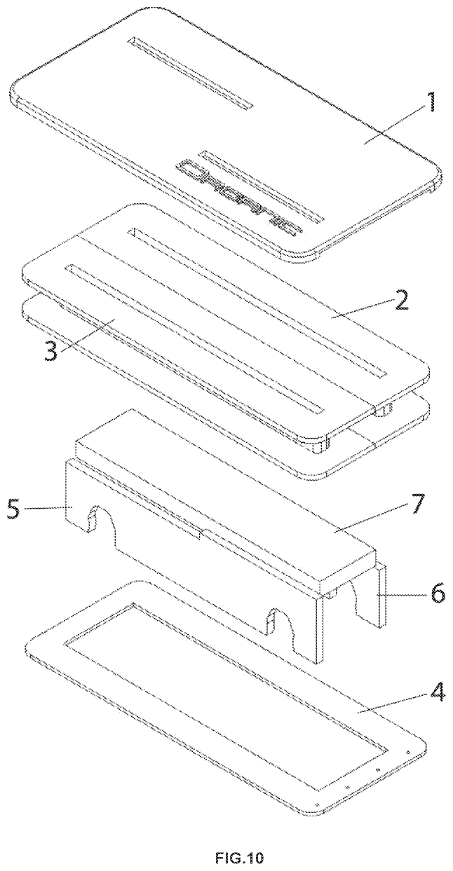

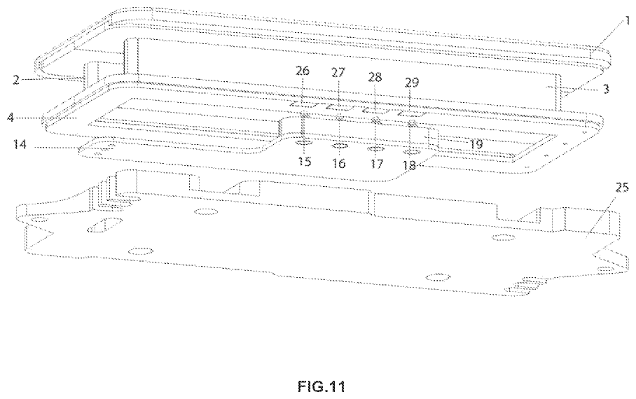

FIG. 10 depicts an exploded perspective view of the pickup module showing in a more detailed manner the female part elements on each metal core 5 and 6 of the positioning mechanism. These female elements work in conjunction with their corresponding male connector elements 10, 11, 12 and 13 shown in FIG. 4. securing each other by a pressure fit enabling to lock the position of the pickup module to the baseplate. The resulting position of both, pickup module and baseplate, once the mechanism is locked, is depicted in FIG. 1. To disengage the mechanism, the pickup module needs to be pulled away from the baseplate to unlock the position releasing the pickup module.

FIG. 11 shows a bottom perspective view of the pickup module and the baseplate, illustrating how both printed circuit boards, 4 attached to the bottom of the bobbins element and 14 placed and fixed to the pickup baseplate (as shown in FIG. 4), interact enabling the electrical connection. The connection pins 15, 16, 17 and 18 are placed and soldered to elements presented on this embodiment, the connection pins 15, 16, 17, and 18 come into contact with the connection terminals 26, 27, 28, and 29 of the PCB 4 attached to the pickup module. For this example, the connection pins used in the described electrical connection mechanism are spring-loaded connector pin type, but this fact does not preclude a different type of connector.

While preferred materials for elements have been described, the device is not limited by these materials. Wood, plastics, rubber, foam, metal, alloys, aluminum and other materials may comprise some or all of the elements of the Interchangeable Electric Guitar Pickup System in various embodiments of the present invention.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1) An interchangeable electric guitar pickup system that allows to use a modular pickup device without the need of a specially designed musical instrument fitted to use this system or irreversibly modifying a standard musical instrument like a guitar or bass guitar.

2) An interchangeable electric guitar pickup system comprising an electric guitar pickup baseplate with one or more male elements and an electric guitar pickup module with one or more female elements that enable a mechanical mounting and electrical connection
